(19) United States
(12) Patent Application Publication
(10) Pub. No.: US 2026/0325378 A1
(43) Pub. Date: Oct. 22, 2026

(54) PATIENT TRANSFER APPARATUS

(71) Applicant: 1899864 Ontario Inc., Stoney Creek (CA)

(72) Inventor: Gerian SLOETJES, Stoney Creek (CA)

(21) Appl. No.: 19/553,280

(22) Filed: Feb. 28, 2026

Related U.S. Application Data
(63) Continuation-in-part of application No. 19/263,693, filed on Jul. 9, 2025.
(60) Provisional application No. 63/668,977, filed on Jul. 9, 2024.

(51) Int. Cl. A61G 7/10

(52) U.S. Cl. CPC A61G 7/1026; A61G 7/1001; A61G 7/1051

(57) ABSTRACT

A patient slider system is provided to transfer a patient from a stretcher. The system comprises a harness system having a plurality of attachment straps, and a tubular slider sheet. The harness system is removably attached to the frame of the stretcher by removing the mattress from the stretcher and threading the ends of each attachment strap through an aperture of the frame. The mattress is then positioned on top of the harness system, and the tubular slider sheet is placed on top of the mattress. The ends of each attachment strap are then removably fastened to attachment sites of the tubular slider sheet. Patient transfer sheets, including the tubular slider sheet, are storable in a holder having a recessed open contour which allows for easy access to the patient transfer sheet. The holder is mountable to the frame of the stretcher using a removable fastener.

### CROSS-REFERENCE TO RELATED APPLICATION

The present application is a continuation-in-part patent application that claims the benefit of priority to U.S. patent application Ser. No. 19/263,693, filed Jul. 9, 2025, which claims the benefit of priority to U.S. provisional patent application Ser. No. 63/668,977, filed Jul. 9, 2024, all of which are hereby incorporated by reference.

### FIELD

The example embodiments disclosed herein relate generally to patient transfer systems, and more specifically, to an apparatus for transferring a patient from a stretcher.

### BACKGROUND

When patients are transported in an ambulance, it is common for the patients to be placed on a stretcher. This can present difficulties when it comes time to transfer the patient from the stretcher to another place (e.g., to a hospital bed). For example, paramedics and/or hospital staff involved in the transfer may be at risk of injury from lifting the patient. The transfer may also be uncomfortable for the patient and/or the transfer may take a long time to complete. Existing solutions include tubular slider sheets placed between the patient and the stretcher; however, existing tubular slider sheets may suffer from limitations related to, for example, ease of installation and/or use, replaceability, reusability, ability to store the sheet when not in use, and harness/attachment mechanism used.

Thus, it is desirable to provide apparatuses to solve at least one problem (e.g., improve ease of installation, ease of transferring the patient, etc.) in emergency medical service (EMS) operations.

### SUMMARY

Example embodiments include, among other features and implementations, a patient slider system that comprises a harness system configured to be removably attached to a frame of a stretcher and a tubular slider sheet configured to be removably fastened to the harness system. The harness system could be pre-installed to be securely attached to a frame of a stretcher, which may help enable the harness system to stay attached to the frame of the stretcher and secured underneath a mattress. Furthermore, because the harness system could be pre-installed and ready for use in-between transfers, time may be saved for users (e.g., paramedics) to perform EMS operations. After the harness system is securely attached to the frame, the tubular slider sheet may be configured to be removably fastened to the harness system such that the tubular slider sheet supporting a patient is secured during transportation. Therefore, the patient and the tubular slider sheeting may be prevented from sliding down the stretcher.

In some examples, the tubular slider sheet is fastened to the harness system, via a hook-and-loop fastener. In one example, the hook-and-loop fastener is Velcro®.

In one possible configuration, the patient slider system may comprise a plurality of harness holders, which may enable the harness system to stay in place (e.g., secured to the frame of the stretcher) and to not shift up or down, left or right.

In some implementations, two sides of the tubular slider sheet may have different coefficients of friction to limit movement of the patient during transportation at one side and facilitate moving the patient from the stretcher (e.g., to a hospital bed) at the other side.

Another example embodiment includes a storage system that comprises a holder that is configured to store a patient transfer sheet and at least two fasteners attached to an outside surface of the holder. The storage system is mountable to an attachment bar, such as an attachment bar of a stretcher. As the storage system could be attached directly to the stretcher by attaching the at least two fasteners to the attachment bar, an integrated storage solution is provided to ensure that the patient transfer sheet is accessible when needed.

According to some aspects, a patient slider system that is configured to transfer a patient from a stretcher, the stretcher including a frame having a plurality of attachment location pairs, each attachment location pair of the plurality of attachment location pairs including two attachment apertures spaced laterally apart from each other by an attachment distance, the stretcher further including a removeable mattress positioned above the frame, the patient slider system includes: a harness system having a plurality of attachment straps and at least one alignment strap, the plurality of attachment straps being spaced along and attached to the at least one alignment strap, each attachment strap of the plurality of attachment straps extending between opposite ends of the attachment strap; wherein the harness system is configured to be removably attached to the frame by, for each attachment strap, positioning the attachment strap across the attachment distance and threading the opposite ends of the attachment strap through the two attachment apertures; a tubular slider sheet having a front side directed away from the stretcher, a rear side opposite the front, and a plurality of attachment site pairs; and wherein the tubular slider sheet is configured to be removably fastened to the harness system by positioning the rear side above the mattress and, for each attachment strap, removably fastening the opposite ends of the attachment strap to an attachment site pair of the plurality of attachment site pairs.

In some examples, the plurality of attachment straps includes a head attachment strap, a torso attachment strap, and a foot attachment strap.

In some examples, the plurality of attachment site pairs includes two head attachment sites, two torso attachment sites, and two foot attachment sites.

In some examples, the opposite ends of the head attachment strap are attached to the two head attachment sites, the opposite ends of the torso attachment strap are attached to the two torso attachment sites, and the opposite ends of the foot attachment strap are attached to the two torso attachment sites.

In some examples, the head attachment strap is configured to be threaded through two head attachment apertures of the frame, the torso attachment strap is configured to be threaded through two torso attachment apertures of the frame, and the foot attachment strap is configured to be threaded through two torso attachment apertures of the frame.

In some examples, the at least one alignment strap includes two alignment straps spaced laterally apart from each other.

In some examples, the at least one alignment strap is configured to be completely covered by the mattress.

In some examples, the plurality of attachment site pairs is positioned on the front side of the tubular slider sheet.

In some examples, each attachment site of each attachment site pair includes a first section of a hook-and-loop fastener, each end of each attachment strap includes a second section of the hook-and-loop fastener, and the second section is configured to be removably fastened to the first section.

In some examples, the hook-and-loop fastener is Velcro®.

In some examples, the patient slider system further includes a plurality of harness holders, and wherein each end of each attachment strap is configured to be further secured to the frame by removably fastening a harness holder of the plurality of harness holders around the end of the attachment strap and around at least a portion of the frame.

In some examples, each attachment strap has a length between the opposite ends, and the length is greater than the attachment distance.

In some examples, the tubular slider sheet is reusable.

In some examples, the tubular slider sheet is replaceable.

In some examples, the front side is configured with a front coating having a front side coefficient of friction, the rear side is configured with a rear coating having a rear side coefficient of friction, and wherein the rear side coefficient of friction is less than the front side coefficient of friction.

In some examples, the rear coating comprises a silicone-modified polyurethane (PU) coating.

In some examples, the rear side coefficient of friction of the silicone-modified PU coating is in a range of 0.1-0.4.

In some examples, the front coating comprises an anti-slip spray coating.

In some examples, the anti-slip spray coating comprises a Flex Seal® spray coating.

According to some aspects, a storage system that is configured to be mountable to an attachment bar for storing a patient transfer sheet, includes: a holder including: a cylindrical body having an open top for receiving an end of the patient transfer sheet and a bottom opposite to the open top, the cylindrical body having a recessed open contour extending from the open top and towards the bottom for allowing increased movement of the patient transfer sheet within the cylindrical body; and at least two fasteners attached to an outside surface of the cylindrical body along an attachment axis and configured to removably attach the cylindrical body to the attachment bar.

In some examples, the at least two fasteners include two snap rings fixedly attached to the outside surface for removably receiving the attachment bar.

In some examples, the at least two fasteners include at least two channels integrally formed with the cylindrical body along the attachment axis, and wherein the cylindrical body is removably attached to the attachment bar by attaching the at least two channels to the attachment bar.

In some examples, the storage system further includes two Velcro® strips, and wherein the cylindrical body is configured to be removably attached to the attachment bar by wrapping the two Velcro® strips around the attachment bar and through the at least two channels.

In some examples, the bottom is closed.

In some examples, the recessed open contour includes at least one beveled edge.

In some examples, the recessed open contour extends along a contour axis parallel to the attachment axis.

In some examples, the cylindrical body has an extent from the top to the bottom, and the recessed open contour extends at least 20% of the extent and less than 50% of the extent.

In some examples, the recessed open contour extends at least 30% of the extent and less than 40% of the extent.

In some examples, the storage system further includes the patient transfer sheet and a harness system which are configured to jointly transfer a patient from a stretcher.

In some examples, the harness system comprises a plurality of attachment straps and at least one alignment strap, the plurality of attachment straps being spaced along and attached to the at least one alignment strap, each attachment strap of the plurality of attachment straps extending between opposite ends of the attachment strap.

In some examples, the patient transfer sheet is a tubular slider sheet having a front side directed away from the stretcher, a rear side opposite the front, and a plurality of attachment site pairs.

In some examples, the front side is configured with a front coating having a front side coefficient of friction, the rear side is configured with a rear coating having a rear side coefficient of friction, and wherein the rear side coefficient of friction is less than the front side coefficient of friction.

In some examples, the rear coating comprises a silicone-modified polyurethane (PU) coating.

In some examples, the front coating comprises an anti-slip spray coating.

In some examples, the anti-slip spray coating comprises a Flex Seal® spray coating.

### DRAWINGS

For a more complete understanding of the example embodiments, and the advantages thereof, reference is now made, by way of example, to the following descriptions taken in conjunction with the accompanying drawings.

FIG. 1 is a side perspective view of an example, existing stretcher;

FIG. 2 is a top view of an example harness system;

FIG. 3 is a top view of an example tubular slider sheet;

FIG. 4 is a top view of the frame from the stretcher of FIG. 1;

FIG. 5 is a top view of FIG. 4 with the harness system of FIG. 2 overlaid;

FIG. 6 is a top view of FIG. 5 with the mattress of FIG. 1 positioned thereon;

FIG. 7 is a top view of FIG. 6 with the tubular slider sheet of FIG. 3 positioned thereon;

FIG. 8 is a front perspective view of a patient being transported on top of the tubular slider sheet of FIG. 3, according to at least one embodiment;

FIG. 9 is a perspective view of an example storage system;

FIG. 10 is a perspective view of the storage system of FIG. 9 with a slider sheet stored therein;

FIG. 11 is a perspective view of another example storage system;

FIG. 12 is a side perspective view of an example storage system attached to an example stretcher;

FIG. 13 is a rear perspective view of FIG. 12;

FIG. 14 is a front view of another example storage system; and

FIG. 15 is a front view of another example storage system.

In the drawings, embodiments are illustrated by way of example. It is to be expressly understood that the description and drawings are only for purposes of illustrating certain embodiments and are an aid for understanding. They are not intended to be a definition of the limits of example embodiments.

### DESCRIPTION OF VARIOUS EXAMPLES

Various apparatuses, systems, or processes will be described below to provide an example of each claimed subject matter. No example described below limits any claimed subject matter and any claimed subject matter may cover processes, systems, or apparatuses that differ from those described below. The claimed subject matter is not limited to apparatuses, systems, or processes having all of the features of any one apparatus, system, or process described below or to features common to multiple or all of the apparatuses, systems, or processes described below. It is possible that an apparatus, system, or process described below is not an example of any claimed subject matter. Any subject matter disclosed in an apparatus, system, or process described below that is not claimed in this document may be the subject matter of another protective instrument, for example, a continuing patent application, and the applicants, inventors, or owners do not intend to abandon, disclaim, or dedicate to the public any such invention by its disclosure in this document.

A conventional patient transfer system is provided to meet modern needs for transporting patients to and from different transportation vehicles, hospital locations such as operating rooms, and examination rooms, or laboratory, treatment, and recovery locations in hospitals or other off-site biomedical or health-care based locations. The transfer sheets of the patient transfer system are easily decontaminated of human waste between uses, making them reusable.

According to some aspects of the example embodiments, a patient slider system for transporting a patient from a stretcher (e.g., to a hospital bed) is disclosed that can help address some of the shortcomings of some existing patient slider systems. The patient slider system of the present example embodiments may include a harness system and a tubular slider sheet which can be configured to transport a patient from a stretcher to a hospital bed with greater ease. In some examples, the harness system can include a plurality of attachment straps and at least one alignment strap, and the tubular slider sheet can include a plurality of attachment sites. Each end of each attachment strap can be threaded through an aperture of the stretcher frame and removably fastened to an attachment site of the tubular slider sheet. The harness system can remain removably fastened to the frame of the stretcher while the tubular slider sheet is unfastened for the transfer, which may help to save time (e.g., time of transferring the patient) for the users in the EMS operations. The tubular slider sheet can be stored in a storage system that is configured to be mountable to an attachment bar, including to an attachment bar of the stretcher. For example, the storage system can be removably fastened to the attachment bar using snaps rings and/or channels for holding a hook-and-loop fastener, such as Velcro®.

In some examples, the tubular slider sheet could be reusable. In other examples, if the tubular slider sheet is soiled, the tubular slider sheet could be replaced.

In some applications, two sides of the tubular slider sheet could have different respective coefficients of friction to facilitate patient transfer. In particular, a rear side of the tubular slider sheet may have a coating with a relatively low coefficient of friction (e.g., a reduced coefficient of friction) to facilitate transferring the patient, for example, from the stretcher (e.g., to a hospital bed) to ensure no movement of the patient during transportation. A front side of the tubular slider sheet may be configured with a coating with a relatively high coefficient of friction (e.g., a coefficient of friction higher than that of the rear side) to ensure no movement of the patient during transportation.

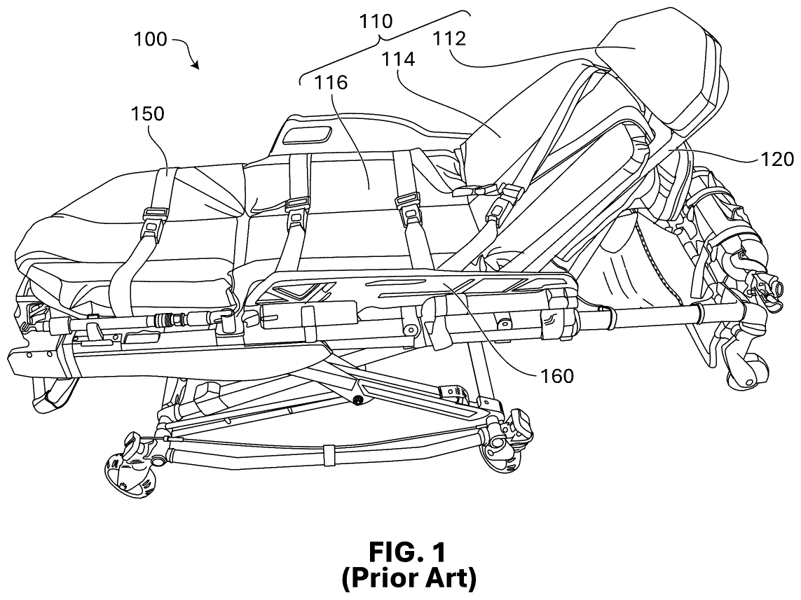

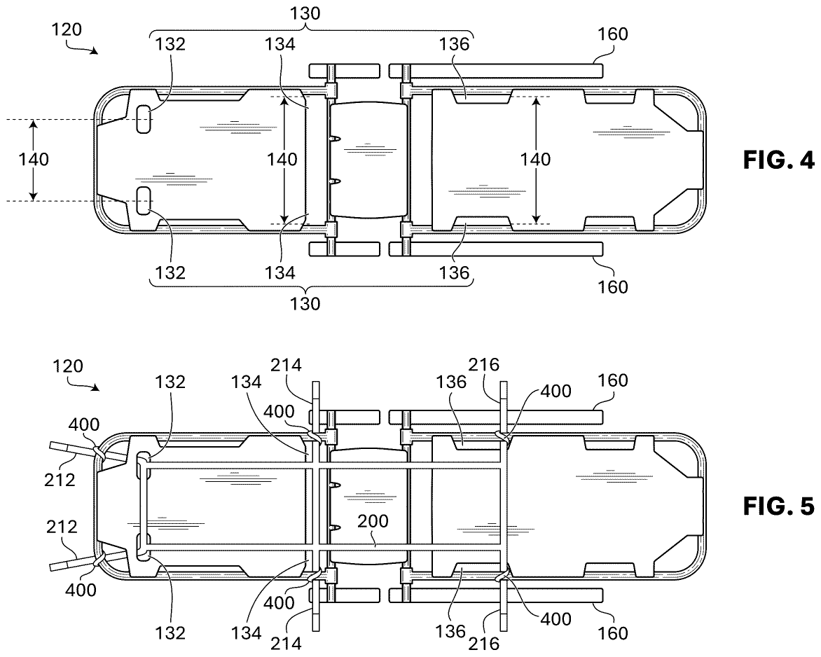

Referring to FIG. 1, a prior art stretcher 100 for transporting a patient is shown. The stretcher 100 includes a removable mattress 110 and a frame 120. The frame 120 includes a plurality of attachment location pairs, which will be described with reference to FIG. 4 below. The mattress 110 may be removably positioned above the frame 120. In some examples, the mattress 110 can be removably fastened to the top side of the frame 120 using, for example, a hook-and-loop fastener such as Velcro®. The mattress 110 may include a head cushion 112, a torso cushion 114, and a foot cushion 116. The stretcher 100 can further include sidearms 160 and stretcher straps 150.

Reference is now made to FIG. 4, which illustrates a top view of a frame of a stretcher, such as the frame 120 as shown in FIG. 1. To assist the illustration of the frame, the mattress 110 has been removed and the sidearms 160 have been placed in their lowest position. This is only illustrative and is not intended to be limiting. In other examples, the mattress 110 and sidearms 160 may have any suitable configuration as needed. As shown in FIG. 4, the frame 120 includes a plurality of attachment location pairs 130. Each attachment location pair 130 includes a pair of spacings, gaps, and/or apertures in the frame 120. In the example illustrated, the plurality of attachment location pairs 130 includes two head apertures 132, two torso apertures 134, and two foot apertures 136, although it will be appreciated that more or less attachment location pairs 130 can be used. In the example of FIG. 4, each attachment location pair 130 may be separated by an attachment distance 140 spanning across a portion of the frame 120.

In the example illustrated, each head aperture 132 is a circular hole in the frame 120, each torso aperture 134 is located in a gap extending toward opposite sides of the frame 120, and each foot aperture 136 is defined by a spacing between two components of the frame 120. However, it will be appreciated that any spacing, gap, and/or aperture in the frame 120 will suffice for an attachment location pair 130, and that the configuration depicted in FIG. 4 is only one possible configuration.

In the example illustrated, the head apertures 132 are positioned in the head portion of frame 120, the torso apertures 134 are positioned in the torso portion, and the foot apertures 136 are positioned in the foot portion. The attachment distance 140 between each attachment location pair 130 need not be the same. For example, the attachment distance 140 between the head apertures 132 may be smaller than the attachment distance 140 between the foot apertures 136. Additionally, in some examples, the attachment distance 140 may not span across a solid portion of the frame 120 (for example, the two torso apertures 134 in FIG. 4 are separated by one large gap in the frame 120).

It will be appreciated that FIG. 1 depicts only one example of an existing stretcher 100 for transporting a patient, and that many different types and/or models of stretchers 100 can be used. For example, a Stryker stretcher or Ferno stretcher can be used.

In the example illustrated, a patient transfer apparatus can be utilized with the stretcher 100 together to transport a patient. Details of the patient transfer apparatus will be described further. For example, the patient transfer apparatus and the stretcher 100 can be used to transport a patient from an ambulance (e.g., to a hospital bed). The stretcher 100 is typically wheeled and moved by paramedics, nurses, hospital staff, Emergency Medical Technicians (EMTs), and/or other Emergency Medical Services (EMS) staff. A patient transfer can occur by wheeling the stretcher 100 next (e.g., to a hospital bed) and by lifting, pulling, and/or pushing the patient (or a sheet placed underneath the patient) from the stretcher 100 to another place (e.g., the hospital bed).

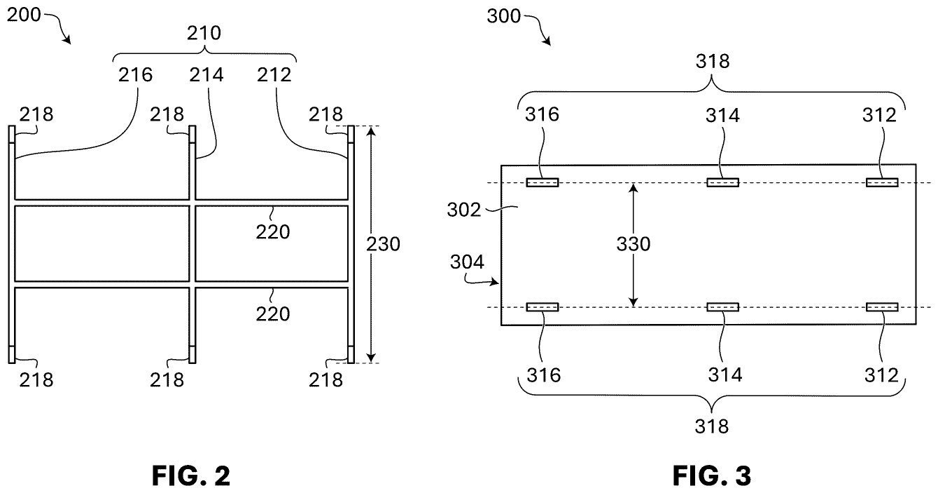

Reference is now made to FIGS. 2 and 3, which illustrate that the patient transfer apparatus comprises a harness system (e.g., a harness system 200 that will be illustrated with reference to FIG. 2) and a tubular slider sheet (e.g., a tubular slider sheet 300 that will be illustrated with reference to FIG. 3) in accordance with example embodiments. The patient transfer apparatus can be used to transfer a patient from a stretcher (e.g., the stretcher 100 as shown in FIG. 1) to a hospital bed. As described herein, the harness system 200 can be removably fastened to the frame 120 of the stretcher 100 and is used to secure the tubular slider sheet 300 during transportation. The tubular slider sheet 300 is disposed above the mattress 110 of the stretcher 100 and increases the safety of the patient transfer by reducing the lifting weight required to transfer the patient from the stretcher 100 to the hospital bed.

Referring to FIG. 2, which presents an example harness system 200 of the patient transfer apparatus in accordance with example embodiments. The harness system 200 can be formed of, for example, nylon. The harness system 200 includes a plurality of attachments straps 210 and at least one alignment strap 220. Although in the example of FIG. 2, the harness system 200 has three attachment straps 210 spaced along two alignment straps 220, this is only illustrative and is not intended to be limiting. It will be appreciated that more or less attachment straps 210 and/or alignment straps 220 can be used than shown in other examples. The plurality of attachment straps 210 can include a head attachment strap 212, a torso attachment strap 214 and/or a foot attachment strap 216. Each attachment strap 210 can include a removable fastener fixed on each end 218 of the attachment strap 210. The fastener disposed at each end 218 of the attachment strap 210 may include one portion of a hook-and-loop fastener, such as Velcro®, that is removably attached to another portion of the hook-and-loop fastener such that the plurality of attachment straps 210 can be removably attached to attachment sites of the tubular slider sheet 300.

As shown in FIG. 2, each attachment strap 210 has a length 230 between the opposite ends 218 of the attachment strap 210 (e.g., the head attachment strap 212, the torso attachment strap 214 and/or the foot attachment strap 216). In some examples, stretchers may have a total width (measured between each side of the stretcher, not including the dimensions of any side rails or sidearms 160) of approximately 22 to 24 inches. In that case, the length 230 of each attachment strap 210 is greater than 22 inches. This allows the attachment strap 210 to cover the width of the frame 120, including the entirety of the attachment distance 140. In some embodiments, the length 230 of each attachment strap 210 is greater than 24 inches, 26 inches, 28 inches, or 30 inches. In other words, the length 230 of each attachment strap 210 may be sufficient to enable the attachment strap 210 to cover the attachment distance 140 and to be threaded through an attachment location pair 130 of the frame 120, and then still have some of the attachment strap 210 left over on each side.

In some examples, the length of the alignment strap 220 may be variable. For example, the length of the alignment strap 220 may be equal to or greater than the length 230 of the attachment strap 210.

Referring to FIG. 3, which presents an example tubular slider sheet 300 now in accordance with example embodiments. The tubular slider sheet 300 has a front side 302 and a rear side 304. The tubular slider sheet 300 also has a plurality of attachment sites 318 configured to be removably fastened to a harness system (e.g., the harness system 200 as shown in FIG. 2). For example, each attachment site 318 may include a portion of a hook-and-loop fastener, such as Velcro®, that is removably attached to another portion of the hook-and-loop fastener such that each attachment site can be removably attached to a fastener at each end 210 of a respective attachment strap 210. In the example of FIG. 3, the tubular slider sheet 300 has six attachment sites 318 in total, with two being head attachment sites 312, two being torso attachment sites 314, and two being foot attachment sites 316. In some examples, the attachment sites 318 are separated into pairs, with each pair being positioned along an axis. The two axes are parallel to each other and separated by an attachment site distance 330. However, it will be appreciated that many different configurations of tubular slider sheet 300 are possible. For example, tubular slider sheet 300 can alternatively include four attachment sites 318, eight attachment sites 318, etc. While the tubular slider sheet 300 can have an odd number of attachment sites 318, an even number may be desirable since it allows for symmetrical attachment of the tubular slider sheet 300 of the patient transfer system to a harness system (e.g., the harness system 200 as depicted with respect to FIG. 2) of the patient transfer apparatus.

In some embodiments, the number of attachment sites 318 may be twice the number of attachment straps 210. As each attachment strap 210 has two ends 218, each end 218 of each attachment strap 210 can correspond to an attachment site 318. Each end 218 can be configured to be removably fastened to its corresponding attachment site 318. For example, each attachment site 318 can include a first section of a hook-and-loop fastener (e.g. the “hook” section or the “loop” section), and each end 218 can include a second section of the hook-and-loop fastener (e.g., the opposite section as the first section). The configurations of each attachment site 318 and each end 218 may enable each end 218 to be removably attached to each attachment site 318. In some embodiments, the hook-and-loop fastener can be Velcro®, although it will be appreciated that other removable fasteners can be used to removably attach each end 218 to each attachment site 318 (such as clips, retaining rings, cotter pins, magnets, etc.).

FIGS. 4-7 show the harness system 200 and the tubular slider sheet 300 configured in various states of attachment to the stretcher 100, according to at least one example embodiment. Before attaching the harness system 200, the mattress 110 is removed from the stretcher 100. If the frame 120 includes several parts, it may be helpful to position them all at the same elevation prior to attachment of the harness system 200. For example, it may be possible to elevate or incline the head portion of the frame 120 above the rest of the frame 120, such as the head-portion elevated state shown in FIG. 1. In such cases, it may be helpful to ensure that the head portion is at the same elevation as the rest of the frame 120. Furthermore, it may also be helpful to lower the sidearms 160 to their lowest position and place all the stretcher straps 150 to the side of the stretcher 100 to facilitate installing the harness system 200.

FIG. 5 illustrates an example of how the harness system 200 is attached or installed to the frame 120. When the mattrass is removed, each end 218 of each attachment strap 210 is threaded through an attachment location of an attachment location pair 130 to removably attach the harness system 200 to the frame 120. As shown in FIG. 5, by way of installing each attachment strap 210 to the frame 120, the head attachment strap 212 is threaded through the head apertures 132, the torso attachment strap 214 is threaded through the torso apertures 134, and the foot attachment strap 216 is threaded through the foot apertures 136. As such, each attachment strap 210 can be positioned across the corresponding attachment distance 140.

The patient transfer apparatus and method of attachment disclosed herein, of threading each end 218 of each attachment strap 210 through an attachment location of an attachment location pair 130 of the frame 120, can provide several benefits. For example, the harness system 200 can be securely fastened to the frame 120 while still being removable. This allows the harness system 200 to stay attached to the frame 120, and secured underneath the mattress 110, even without attaching the tubular slider sheet 300. When the tubular slider sheet 300 is attached to the harness system 200, and the patient stays above the tubular slider sheet 300, the harness system 200 and the tubular slider sheet 300 attaching with the harness system 200 (and the patient) may be prevented from sliding down the stretcher 100 as each attachment strap 210 is secured to the frame 120 and prevented from sliding down the frame 120. Thus, this feature provides a safety advantage (by preventing the patient from sliding down the stretcher 100) and also a functional advantage (by keeping the harness system 200 installed and ready for use in-between transfers).

It will be appreciated that several different orientations of each attachment strap 210, and of each end 218, are possible for threading the attachment strap 210 through the attachment location pair 130. For example, each attachment strap 210 can be threaded through an attachment location of the attachment location pair 130 in a direction which is generally perpendicular to the long dimension of the frame 120 (e.g. the torso attachment strap 214 and foot attachment strap 216 shown in FIG. 5). In other examples, each attachment strap 210 can also be threaded through an attachment location of the attachment location pair 130 in a direction which is generally parallel to the long dimension of the frame 120 (e.g. the head attachment strap 212 in FIG. 5). Of course, many other orientations than those shown in FIG. 5 are also possible, including any orientation in-between generally perpendicular and generally parallel. For example, the head attachment strap 212 may also be threaded through an attachment location of the attachment location pair 130 in a direction which is generally perpendicular to the long dimension of the frame 120.

In some examples, the patient transfer apparatus may further comprise a plurality of harness holders 400 as shown in FIG. 5. When installing the attachment straps 210 to the frame 120, the plurality of harness holders 400 may be used to further secure the harness system 200 to the frame 120, for example, after threading the attachment straps 210 through the attachment location pairs 130. In some examples, each harness holder 400 may include a strap with ends which can be removably fastened together (e.g. using a hook-and-loop fastener, such as Velcro®). After threading each end 218 through each attachment location of the frame 120, the harness holder 400 can be wrapped around both the attachment strap 210 and a portion of the frame 120, with the ends of the harness holder 400 then being removably fastened together. As such, the harness holders 400 provides additional securement of the harness system 200 to the frame 120. The harness holders 400 can also be particularly useful in preventing the attachment straps 210 from hanging down below the frame 120 in a position which would be difficult to reach by a user. That is, the harness holders 400 can help to keep a portion of each attachment strap 210 securely fastened near the side of the frame 120 where it can be easily grabbed.

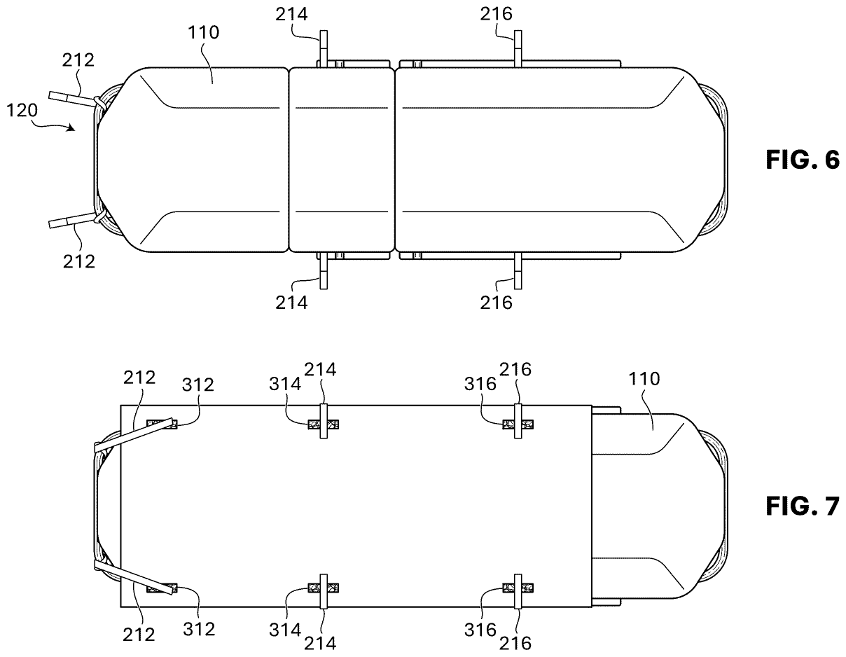

FIG. 6 shows an example in which the mattress 110 of the stretcher is placed back after the harness system is installed to securely attach the frame 120. As shown in FIG. 6, after the mattress 110 is placed back on the frame 120, the mattress 110 is disposed on top of the harness system 200. The ends 218 of each attachment strap 210 (e.g., the head attachment strap 212, the torso attachment strap 214, and/or the foot attachment strap 216) can be positioned to hang out over the sides of the frame 120. In the example illustrated, the mattress 110 covers the entirety of the alignment straps 220.

FIG. 7 presents an example where ends of each attachment strap of the harness system are attached to attachment sites of the tubular slider sheet. In particular, after the mattress 110 is placed back on the frame 120, the tubular slider sheet 300 is then placed on top of the mattress 110. The ends 218 of each attachment strap 210 (e.g., the head attachment strap 212, the torso attachment strap 214, and/or the foot attachment strap 216) are then removably fastened to the tubular slider sheet 300 using the attachment sites 318 (e.g., the head attachment sites 312, the torso attachment sites 314, the and/or foot attachment sites 316). In the example illustrated, the head attachment strap 212 that has been threaded through the head apertures 132 as shown in FIG. 4 is removably fastened to the head attachment sites 312. Similarly, the torso attachment strap 214 that has been threaded through the torso apertures 134 as shown in FIG. 4 is removably fastened to the torso attachment sites 314, and the foot attachment strap 216 that has been threaded through the foot apertures 136 is removably fastened to the foot attachment sites 316.

In the example of FIG. 7, each attachment site 318 (e.g., the head attachment sites 312, the torso attachment sites 314, the and/or foot attachment sites 316) is shaped as an oblong rectangle having a long side parallel to the long side of the tubular slider sheet 300. The ends 218 of each attachment strap 210 can be removably fastened in a generally perpendicular direction to the attachment site 318. As each attachment site 318 is a long rectangle (or strip), this provides a long region for the attachment strap 210 to attach to (this is particularly useful if the attachment sites 318 of the tubular slider sheet 300 are not aligned perfectly with the attachment locations 130 of the frame 120). However, it will be appreciated that other configurations are possible, as well as other shapes for the attachment sites 318. For example, the head attachment straps 212 can be positioned in a direction which is generally parallel to the head attachment sites 312, depending on the orientation in which they are threaded through the head apertures 132. The attachment sites 318 could also, for example, have a circular shape or an alternative rectangular shape.

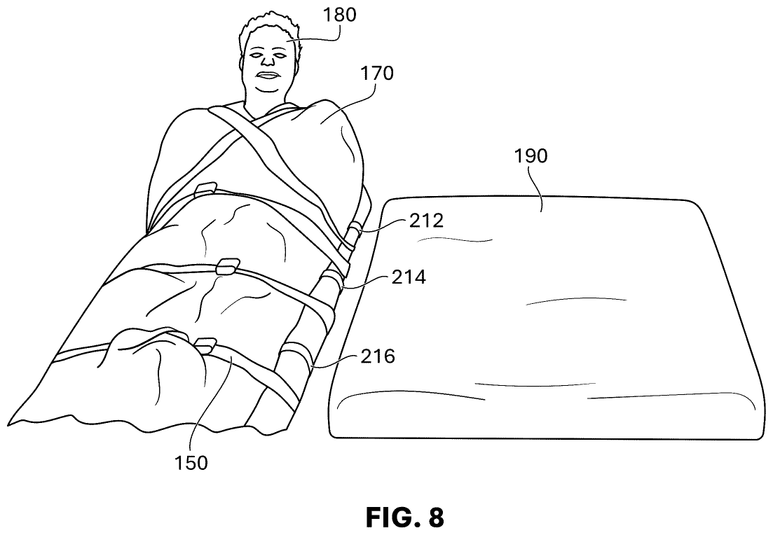

Reference is now made to FIG. 8, which illustrates that a patient 180 is being transported from the stretcher 100 where the harness system 200 is installed to the frame 120, and tubular slider sheet 300 is attached to the harness system 200. The patient 180 may be wrapped in a patient sheet 170, and the stretcher straps 150 may be buckled. However, the patient sheet 170 need not be wrapped around the patient 180 and may simply sit in between the patient 180 and the mattress 110. The patient sheet 170 may be referred to as a contralateral sheet. To facilitate the transfer, the stretcher 100 can be positioned next to the hospital bed 190, the stretcher straps 150 can be unbuckled, and the stretcher 100 and hospital bed 190 can be placed at similar elevations. The attachment straps 210 are then unfastened from the attachment sites 318 of the tubular slider sheet 300.

In at least one embodiment, two paramedics may be preferred for the transfer, with one positioned on each side of the stretcher 100 (not shown). It may be beneficial to use two paramedics, as each paramedic can hold a side of the patient sheet 170 and push/pull/lift the patient sheet 170 to transfer the patient 180 from the stretcher 100 to the hospital bed 190. The tubular slider sheet 300 facilitates and promotes the transfer by reducing the force required to transfer the patient 180. In some examples, the tubular slider sheet 300 may move with the patient 180 during the transfer. In such cases, the tubular slider sheet 300 could be easily removed after the transfer by lifting one side of the patient sheet 170 and pulling the tubular slider sheet 300 out under the patient 180.

In some examples, the tubular slider sheet 300 can then be reattached to the harness system 200 by removably fastening each end 218 of each attachment strap 210 to an attachment site 318, as discussed above. Alternatively, the tubular slider sheet 300 may be stored for future use. Thus, the tubular slider sheet 300 is reusable and can be used for many patient transfers. The tubular slider sheet 300 can be wiped clean with a service approved disinfecting wipe between uses. This allows the tubular slider sheet 300 to be immediately redeployed after use. If the tubular slider sheet 300 is soiled, it may also be machine washed. In some examples, the tubular slider sheet 300 is also reusable, replaceable, and cleanable, and may be more durable than the patient sheet 170.

It will be appreciated that while the tubular slider sheet 300 is unfastened from the harness system 200 during the patient transfer, the harness system 200 can stay removably attached to the frame 120 during this time. As such, the patient slider system (e.g., including the harness system 200 and the tubular slider sheet 300) can be quickly reconfigured for use after a transfer, since the harness system 200 stays attached the entire time. An additional benefit of said patient slider system is that each component (e.g., including the harness system 200 and the tubular slider sheet 300) is individually replaceable. For example, if the tubular slider sheet 300 is extremely worn and/or soiled, it can simply be replaced with another tubular slider sheet 300 without the need to replace the harness system 200. This also allows for different types of slider sheets to be attached to the harness system 200. Furthermore, the removable attachment configuration of the harness system 200 and the tubular slider sheet 300 may enable different types of harness systems to be attached to the tubular slider sheet 300. As the harness system 200 includes attachment straps 210 which are threaded through apertures of the frame 120, the attachment straps 210 are also prevented from slipping down the frame 120. What is more, as the attachment straps 210 are securely installed to attach the frame 120, the patient 180 similarly slipping down the frame 120 may be mitigated.

To help to facilitate the transfer, one side of the tubular slider sheet 300 may be configured with a reduced coefficient of friction which may enable the patient sheet 170 (e.g., wrapping the patient 180 or supporting the patient 180) to be moved with greater ease.

In some examples, the tubular slider sheet 300 can be coated to help facilitate the transfer. For example, the rear side 304 (which faces down towards the mattress 110) can be coated with a rear coating. In some examples, the rear coating is a slippery coating which reduces the coefficient of friction between the rear side 304 and the mattress 110 to reduce the force required to transfer the patient 180 from the stretcher 100 to the hospital bed 190. The slippery coating can be, for example, a silicone-modified polyurethane (PU) coating. The coefficient of friction of the silicone-modified PU coating can be in a range of 0.1-0.4.

The front side 302 (which faces up towards the patient 180) may be coated with a front coating. In some examples, the front coating is a non-slip coating which increases the coefficient of friction between the front side 302 and the patient 180 (or patient sheet 170). The non-slip coating can help to ensure that the patient 180 does not slide off the tubular slider sheet 300 and/or off the stretcher 100. The non-slip coating can be, for example, a rubberized adhesive top coat or an anti-slip spray coating. In some examples, the anti-slip spray coating can be a Flex Seal® spray coating.

In some examples, the coefficient of friction of the slippery coating may be less than the coefficient of friction of the non-slip coating. For example, the silicon-modified PU coating can have a static coefficient of friction of approximately 0.15-0.40 and a dynamic coefficient of friction of approximately 0.10-0.30, and the anti-slip spray coating can have a static coefficient of friction of approximately 0.60-0.90 and a dynamic coefficient of friction of approximately 0.50-0.80.

In some examples, the front side 302 and the rear side 304 can both be coated with the slippery coating. In other examples, the front side 302 and the rear side 304 can both be coated with the non-slip coating.

The tubular shape of the sheet can also help facilitate the patient transfer as it allows the front side 302 and rear side 304 to shift relative to each other. This enables the front side 302, which supports the patient 180, to be easily shifted relative to the rear side 304, which is placed in adjacent contact with the mattress 110.

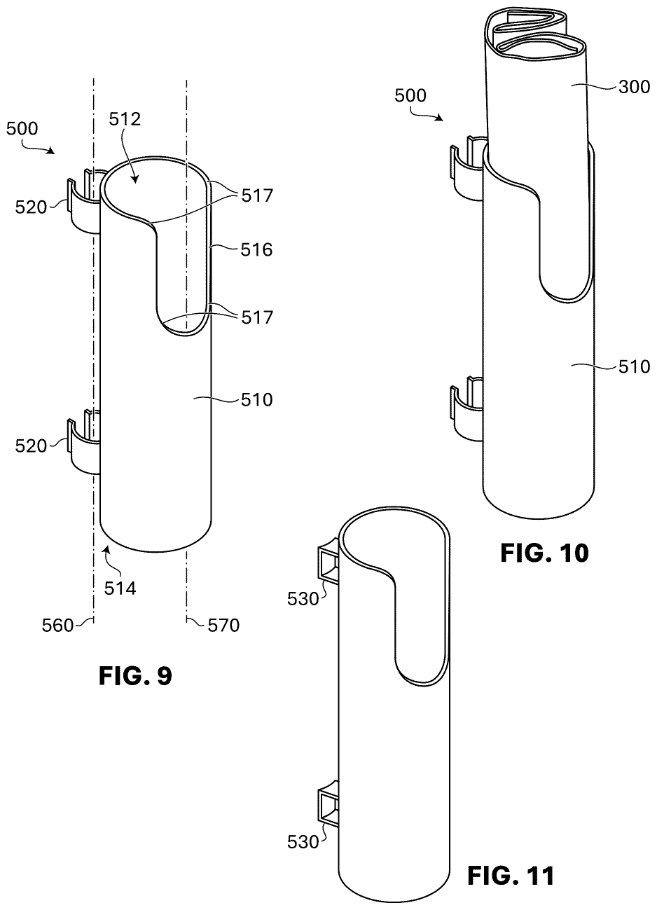

FIG. 9 illustrates a storage system 500 for storing a patient transfer sheet, such as the tubular slider sheet 300 as shown in FIG. 3, in accordance with example embodiments. The storage system 500 includes a holder shaped as a cylindrical body 510. The cylindrical body 510 includes a top 512 and a bottom 514. As shown in FIG. 9, the top 512 is open, the bottom 514 is closed, and the cylindrical body 510 is hollow inside. The cylindrical body 510 further includes a recessed open contour 516 extending from the top 512 and towards the bottom 514. The recessed open contour 516 allows for increased movement of the patient transfer sheet within the cylindrical body 510. This is particularly useful when inserting or removing the patient transfer sheet from the cylindrical body 510, as it provides a recess or groove in which the sheet can be placed in and/or pulled out of. This can reduce the force required to insert or remove the patient transfer sheet from the cylindrical body 510, as much of the patient transfer sheet can be angled during insertion/removal. This reduces the surface area of the patient transfer sheet which is in contact with the interior of the cylindrical body 510 and therefore reduces the frictional forces acting against removal/insertion of the patient transfer sheet.

In the example illustrated, the recessed open contour 516 extends along a contour axis 570. In said example, each edge 517 of the recessed open contour 516 is beveled or rounded. The cylindrical body 510 has a length or extent separating the top 512 from the bottom 514, and the recessed open contour 516 extends along at least a portion of said extent. In some embodiments, the recessed open contour 516 may extend at least 20% of the extent and less than 50% of the extent. In further embodiments, the recessed open contour 516 may extend at least 30% of the extent and less than 40% of the extent. In further embodiments, the recessed open contour 516 may extend approximately 36% of the extent. In some examples, the extent is approximately 11 inches long and the recessed open contour 516 extends approximately 4 inches of that extent. In some examples, the cylindrical body 510 has a diameter of approximately 3 inches, and the recessed open contour 516 has a width of approximately 2 inches. However, it will be appreciated that many different types of recessed open contours 516 are possible and that the recessed open contour 516 depicted in the Figures, as well as the accompanying description herein, is not intended to limit the shape, size and/or configuration of recessed open contour 516.

In the example of FIG. 9, the storage system 500 further includes at least two fasteners attached to an outside surface of the cylindrical body 510 along an attachment axis 560. In said example, the attachment axis 560 is parallel to the contour axis 570. The fasteners can be used to removably attach the storage system 500 to an attachment bar, such as an attachment bar of a stretcher, such as an attachment bar of the stretcher 100. In FIG. 9, snap rings 520 are shown as a type of the two fasteners. The snap rings 520 can be configured to be removably attached to the attachment bar. However, it will be appreciated that other types of fasteners can also be used. For example, FIG. 11 depicts two channels 530 integrally formed with an outside surface of the cylindrical body 510 as the two fasteners. In the example shown in FIG. 11, a Velcro® strip can be threaded through each channel 530 and wrapped around the attachment bar to removably fasten the cylindrical body 510 to the attachment bar. As the storage system 500 can be attached directly to a stretcher, it provides an integrated storage solution that ensures that the patient transfer sheet is always accessible when needed.

Referring to FIG. 10, which shows that a patient transfer sheet is placed inside the cylindrical body 510 of the storage system 500. The patient transfer sheet can be rolled and/or folded such that it fits snugly inside of the cylindrical body 510. For example, the patient transfer sheet can be folded lengthwise and then rolled, like a sleeping bag, to fit inside the cylindrical body 510.

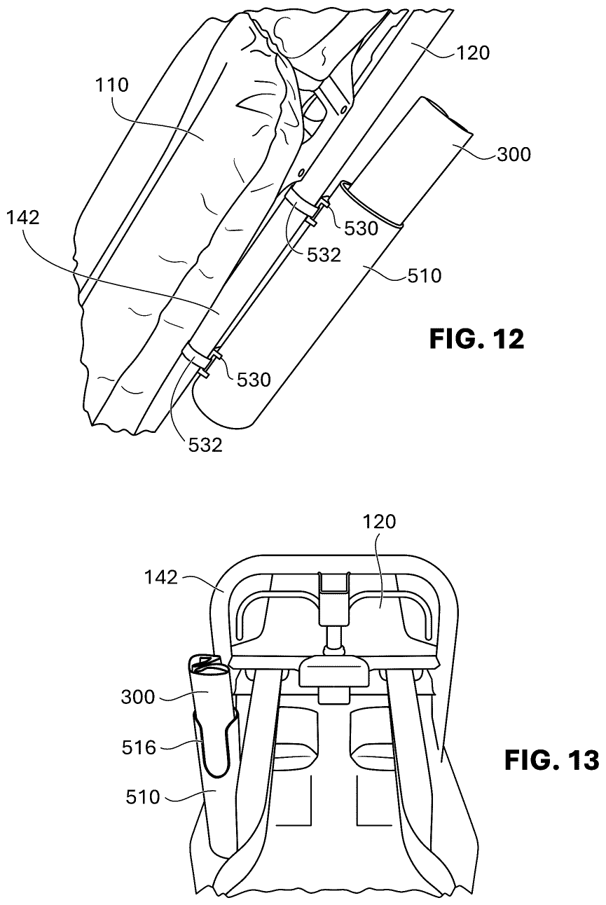

FIGS. 12 and 13 illustrate how the cylindrical body 510 of the storage system 500 is fastened to an attachment bar 142 of the stretcher 100, with the tubular slider sheet 300 stored therein. It will be appreciated, however, that other types of patient transfer sheets can be stored therein and the attachment bar 142 need not be part of the stretcher 100. For example, the attachment bar 142 can be part of a different stretcher than that shown in FIG. 12 or may be entirely separate from a stretcher (for example, attachment bar 142 can be part of an ambulance). In the example illustrated, Velcro® strips 532 are threaded through the channels 530, around the attachment bar 142 of the frame 120, with each end of the Velcro® strip 532 being removably fastened together. It will be appreciated that, instead of the Velcro® strips 532, a different type of hook-and-loop fastener could be used, and/or a different type of removable fastener altogether (for example, the snap ring configuration shown in FIG. 9 can be used). FIG. 13 depicts a rear configuration where the cylindrical body 510 storing the tubular slider sheet 300 is fastened to the attachment bar 142 of the stretcher 100.

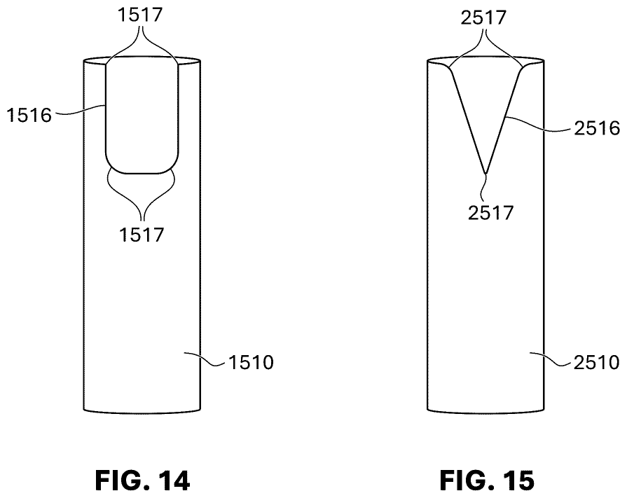

Referring to FIG. 14, in the example illustrated, an alternative example of a storage system for storing a patient transfer sheet is shown. As shown in FIG. 14, a storage system 1500 is an alternative example of the storage system 500. The storage system 1500 comprises a cylindrical body 1510 that has a recessed open contour 1516 with edges 1517. However, in the example illustrated, the top two edges 1517 of the recessed open contour 1516 are straight edges (e.g., 90 degrees) and the bottom two edges 1517 are beveled or rounded.

FIG. 15 shows another example of a storage system (e.g., a storage system 2500) for storing a patient transfer sheet. The storage system 2500 is an alternative embodiment of the storage system 500. As demonstrated in FIG. 15, the storage system 2500 comprises a cylindrical body 2510 that has a recessed open contour 2516 with edges 2517. However, in the example illustrated, the recessed open contour 2516 may have only three edges 2517 (thus making a triangular shape). Additionally, the top two edges 2517 are beveled or rounded, with the bottom edge 2517 ending in a point.

The embodiments shown in FIGS. 14 and 15 are only two possible examples of the shape that the recessed open contour can take. It will be appreciated that many different types of shapes and profiles are possible, and that those shown in the Figures are intended to be examples only and are by no means limiting.

In example embodiments, the terms “a” or “an” are defined to mean “at least one”, that is, these terms do not exclude a plural number of items, unless stated otherwise.

In example embodiments, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In example embodiments, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In example embodiments, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In example embodiments, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In example embodiments, “at least one” means one or more, and “a plurality of” means two or more. The term “and/or” describes an association relationship of associated objects and indicates that three relationships may exist. For example, A and/or B may indicate the following three cases: Only A exists, both A and B exist, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

It is clear that a person skilled in the art can make various modifications and variations to this application without departing from the scope of the example embodiments. The example embodiments are intended to cover these modifications and variations of this application provided that they fall within the scope of protection defined by the following claims and their equivalent technologies.

What has been described above is intended to be illustrative of examples of the example embodiments disclosed herein, without limiting the scope of patent claims granted here from. The scope of such claims should be given the broadest interpretation consistent with the description as a whole.

1. A patient slider system that is configured to transfer a patient from a stretcher, the stretcher including a frame having a plurality of attachment location pairs, each attachment location pair of the plurality of attachment location pairs including two attachment apertures spaced laterally apart from each other by an attachment distance, the stretcher further including a removeable mattress positioned above the frame, the patient slider system comprising:
a harness system having a plurality of attachment straps and at least one alignment strap, the plurality of attachment straps being spaced along and attached to the at least one alignment strap, each attachment strap of the plurality of attachment straps extending between opposite ends of the attachment strap;
wherein the harness system is configured to be removably attached to the frame by, for each attachment strap, positioning the attachment strap across the attachment distance and threading the opposite ends of the attachment strap through the two attachment apertures;
a tubular slider sheet having a front side directed away from the stretcher, a rear side opposite the front, and a plurality of attachment site pairs; and
wherein the tubular slider sheet is configured to be removably fastened to the harness system by positioning the rear side above the mattress and, for each attachment strap, removably fastening the opposite ends of the attachment strap to an attachment site pair of the plurality of attachment site pairs.

2. The patient slider system of claim 1, wherein the plurality of attachment straps includes a head attachment strap, a torso attachment strap, and a foot attachment strap.

3. The patient slider system of claim 2, wherein the plurality of attachment site pairs includes two head attachment sites, two torso attachment sites, and two foot attachment sites.

4. The patient slider system of claim 3, wherein the opposite ends of the head attachment strap are attached to the two head attachment sites, the opposite ends of the torso attachment strap are attached to the two torso attachment sites, and the opposite ends of the foot attachment strap are attached to the two torso attachment sites.

5. The patient slider system of claim 2, wherein the head attachment strap is configured to be threaded through two head attachment apertures of the frame, the torso attachment strap is configured to be threaded through two torso attachment apertures of the frame, and the foot attachment strap is configured to be threaded through two torso attachment apertures of the frame.

6. The patient slider system of claim 1, wherein the at least one alignment strap includes two alignment straps spaced laterally apart from each other.

7. The patient slider system of claim 1, wherein the at least one alignment strap is configured to be completely covered by the mattress.

8. The patient slider system of claim 1, wherein the plurality of attachment site pairs is positioned on the front side of the tubular slider sheet.

9. The patient slider system of claim 1, wherein each attachment site of each attachment site pair includes a first section of a hook-and-loop fastener, each end of each attachment strap includes a second section of the hook-and-loop fastener, and the second section is configured to be removably fastened to the first section.

10. The patient slider system of claim 9, wherein the hook-and-loop fastener is Velcro®.

11. The patient slider system of claim 1, further comprising a plurality of harness holders, and wherein each end of each attachment strap is configured to be further secured to the frame by removably fastening a harness holder of the plurality of harness holders around the end of the attachment strap and around at least a portion of the frame.

12. The patient slider system of claim 1, wherein each attachment strap has a length between the opposite ends, and the length is greater than the attachment distance.

13. The patient slider system of claim 1, wherein the tubular slider sheet is reusable.

14. The patient slider system of claim 1, wherein the tubular slider sheet is replaceable.

15. The patient slider system of claim 1, wherein the front side is configured with a front coating having a front side coefficient of friction, the rear side is configured with a rear coating having a rear side coefficient of friction, and wherein the rear side coefficient of friction is less than the front side coefficient of friction.

16. The patient slider system of claim 15, wherein the rear coating comprises a silicone-modified polyurethane (PU) coating.

17. The patient slider system of claim 16, wherein the rear side coefficient of friction of the silicone-modified PU coating is in a range of 0.1-0.4.

18. The patient slider system of claim 15, wherein the front coating comprises an anti-slip spray coating.

19. The patient slider system of claim 18, wherein the anti-slip spray coating comprises a Flex Seal® spray coating.

20. A storage system that is configured to be mountable to an attachment bar for storing a patient transfer sheet, comprising:
a holder including:
a cylindrical body having an open top for receiving an end of the patient transfer sheet and a bottom opposite to the open top, the cylindrical body having a recessed open contour extending from the open top and towards the bottom for allowing increased movement of the patient transfer sheet within the cylindrical body; and
at least two fasteners attached to an outside surface of the cylindrical body along an attachment axis and configured to removably attach the cylindrical body to the attachment bar.

21. The storage system of claim 20, wherein the at least two fasteners include two snap rings fixedly attached to the outside surface for removably receiving the attachment bar.

22. The storage system of claim 20, wherein the at least two fasteners include at least two channels integrally formed with the cylindrical body along the attachment axis, and wherein the cylindrical body is removably attached to the attachment bar by attaching the at least two channels to the attachment bar.

23. The storage system of claim 22, further comprising two Velcro® strips, and wherein the cylindrical body is configured to be removably attached to the attachment bar by wrapping the two Velcro® strips around the attachment bar and through the at least two channels.

24. The storage system of claim 20, wherein the bottom is closed.

25. The storage system of claim 20, wherein the recessed open contour includes at least one beveled edge.

26. The storage system of claim 20, wherein the recessed open contour extends along a contour axis parallel to the attachment axis.

27. The storage system of claim 20, wherein the cylindrical body has an extent from the top to the bottom, and the recessed open contour extends at least 20% of the extent and less than 50% of the extent.

28. The storage system of claim 27, wherein the recessed open contour extends at least 30% of the extent and less than 40% of the extent.

29. The storage system of claim 20, further comprising the patient transfer sheet and a harness system which are configured to jointly transfer a patient from a stretcher.

30. The storage system of claim 29, wherein the harness system comprises a plurality of attachment straps and at least one alignment strap, the plurality of attachment straps being spaced along and attached to the at least one alignment strap, each attachment strap of the plurality of attachment straps extending between opposite ends of the attachment strap.

31. The storage system of claim 29, wherein the patient transfer sheet is a tubular slider sheet having a front side directed away from the stretcher, a rear side opposite the front, and a plurality of attachment site pairs.

32. The storage system of claim 31, wherein the front side is configured with a front coating having a front side coefficient of friction, the rear side is configured with a rear coating having a rear side coefficient of friction, and wherein the rear side coefficient of friction is less than the front side coefficient of friction.

33. The storage system of claim 32, wherein the rear coating comprises a silicone-modified polyurethane (PU) coating.

34. The storage system of claim 32, wherein the front coating comprises an anti-slip spray coating.

35. The storage system of claim 34, wherein the anti-slip spray coating comprises a Flex Seal® spray coating.
